(19) United States
(12) Patent Application Publication
(10) Pub. No.: US 2022/0184533 A1
(43) Pub. Date: Jun. 16, 2022

(54) FILTER

(71) Applicant: QUA KOREA CO.,LTD, Cheongju-si (KR)

(72) Inventors: Chul Hee PARK, Cheongju-si (KR); Su Kyung KIM, Cheongju-si (KR)

(21) Appl. No.: 17/349,908

(22) Filed: Jun. 16, 2021

(30) Foreign Application Priority Data
Dec. 11, 2020 (KR) 10-2020-0173434

(51) Int. Cl. B01D 24/40; B01D 24/16; B01D 35/14; B01D 24/42

(52) U.S. Cl. CPC B01D 24/40; B01D 24/42; B01D 35/14; B01D 24/16

(57) ABSTRACT

The present disclosure relates to a filter. According to the present disclosure, there is provided a filter including: an upper body whose interior is filled with a filter medium; a lower body located under the upper body in such a manner as to be open on top and bottom thereof; and an escape prevention member located inside the lower body to allow sludge and a fluid to be introduced into the lower body and to prevent the sludge from escaping from the lower body, wherein the escape prevention member may include: a support plate fixed to the inside of the lower body and having a through hole formed at the center thereof; a center pipe fixed to top of the support plate and having a lower hole formed on the bottom thereof in such a manner as to communicate with the through hole and at least one or more connection holes formed on one side thereof; and a backflow prevention ball movable inside the center pipe in such a manner as to selectively open and close the lower hole to prevent the fluid from flowing back.

### TECHNICAL FIELD

The present disclosure relates to a filter.

### BACKGROUND ART

Generally, a filter, which is used in the interior of a water tank to filter the water in the water tank, is classified into a side filter and a sponge filter attached to the wall surface of the water tank and a bottom filter disposed on the bottom of the water tank.

Among such filters, the bottom filter used on the bottom of the water tank is configured to pass a fluid entering the interior thereof through a filter medium disposed therein and then to return the fluid to the interior of the water tank from a water outlet through air or an underwater motor.

When a conventional filter is removed from the water tank, however, the filter may cause the sludge collected in the interior thereof to escape therefrom to the interior of the water tank. As a result, it is hard to remove the sludge from the interior of the water tank.

Further, the conventional filter may break oil films only on the water outlet thereof, thereby failing to gently remove the oil films produced on the surface of water. Additionally, the conventional filter may form an oil film staying sections behind the water outlet thereof and produce vortexes within the water outlet, thereby failing to easily discharge the fluid.

### SUMMARY

Accordingly, the present disclosure has been made in view of the above-mentioned problems occurring in the related art, and it is an object of the present disclosure to provide a filter that is capable of preventing the sludge collected therein from escaping therefrom to the interior of a water tank when removed from the water tank.

It is another object of the present disclosure to provide a filter that is capable of preventing oil film staying sections from being produced behind a water outlet thereof and gently removing the oil films produced on the surface of water.

To accomplish the above-mentioned objects, according to one aspect of the present disclosure, there is provided a filter including: an upper body whose interior is filled with a filter medium; a lower body located under the upper body in such a manner as to be open on top and bottom thereof; and an escape prevention member located inside the lower body to allow sludge and a fluid to be introduced into the lower body and to prevent the sludge from escaping from the lower body, wherein the escape prevention member may include: a support plate fixed to the inside of the lower body and having a through hole formed at the center thereof; a center pipe fixed to top of the support plate and having a lower hole formed on the bottom thereof in such a manner as to communicate with the through hole and at least one or more connection holes formed on one side thereof; and a backflow prevention ball movable inside the center pipe in such a manner as to selectively open and close the lower hole to prevent the fluid from flowing back.

Further, the filter may include a connector located between the upper body and the lower body to allow the inside of the upper body to communicate with the inside of the lower body and an inflow prevention member located at the inside of the connector to prevent the sludge introduced into the inside of the lower body from entering the upper body.

Further, the filter may include a lower cover adapted to surroundingly cover the lower portion of the lower body and having at least one or more inflow holes formed radially thereon and an opening and closing plate connected to the lower cover and having at least one or more opening and closing holes formed radially thereon in such a manner as to selectively open and close the inflow holes.

Further, the filter may include a water discharge pipe connected to top of the upper body on one end portion thereof in such a manner as to discharge the fluid passing through the lower body, the escape prevention member, and the upper body.

Further, the filter may include an air supply member connected to the upper portion of the upper body to supply air to the fluid.

Further, the filter may include a base member connected to the underside of the opening and closing plate in such a manner as to close the undersides of the opening and closing holes to prevent sand from being introduced through the undersides of the opening and closing holes.

Further, the filter may include a height adjustment pipe located between the upper body and the water discharge pipe in such a manner as to connect the upper body to the water discharge pipe and to adjust the height of the water discharge pipe.

To accomplish the above-mentioned objects, according to another aspect of the present disclosure, there is provided a filter including: an upper body whose interior is filled with a filter medium; a lower body located under the upper body in such a manner as to be open on top and bottom thereof; and a water discharge pipe connected to top of the upper body on one end portion thereof in such a manner as to discharge the fluid passing through the lower body, the escape prevention member, and the upper body, wherein the water discharge pipe comprises a fluid inlet formed on one side thereof to prevent a vortex from being generated from the interior thereof.

Also, the other end portion of the water discharge pipe is connected to a luminescent cap or made of a luminescent material.

To accomplish the above-mentioned objects, according to yet another aspect of the present disclosure, there is provided a filter including: an upper body whose interior is filled with a filter medium; a lower body located under the upper body in such a manner as to be open on top and bottom thereof; and a water discharge pipe connected to top of the upper body on one end portion thereof in such a manner as to discharge the fluid passing through the lower body, the escape prevention member, and the upper body, wherein the water discharge pipe may include: an underwater pipe bentedly shaped in such a manner as to be connected to top of the upper body; and over water wings protruding upward from both sides of top of the underwater pipe in such a manner as to form inflow spaces, together with the underwater pipe, to allow the fluid behind an outlet of the underwater pipe to flow to the outlet of the underwater pipe.

Further, the water discharge pipe may include an upward convex arch-shaped over water cap whose both ends are connected to the top ends of the over water wings in such a manner as to connect the over water wings to each other.

Further, the over water cap may include a front portion inclined forward therefrom to prevent air bubbles from being attached to the inside thereof.

Further, the underwater pipe may include a top end portion adapted to form a stepped portion between the fluid discharged to the outlet thereof from an inlet thereof and the fluid flowing to the outlet thereof through the inflow spaces.

According to the present disclosure, the filter can prevent the sludge collected therein from escaping therefrom to the interior of the water tank by means of the escape prevention member when removed from the water tank.

According to the present disclosure, in addition, the filter can be configured to allow the oil films to be broken on the inlet of the water discharge pipe as well as the fluid inflow hole or the top end portion of the underwater pipe, thereby gently removing the oil films produced on the surface of water. Further, the filter can reduce the oil film staying sections produced from the water tank by means of the fluid inflow hole or the inflow spaces.

### BRIEF DESCRIPTION OF DRAWINGS

FIG. 1 is a sectional view showing a filter according to the present disclosure.

FIG. 2 is a sectional view showing the lower portion of the filter according to the present disclosure.

FIGS. 3a and 3b are top and side views showing an escape prevention member of the filter according to the present disclosure.

FIGS. 4a to 4d are sectional views showing a process of storing sludge in the interior of a lower body through the escape prevention member in the filter according to the present disclosure.

FIG. 5 is a view showing the lower cover of the filter according to the present disclosure.

FIG. 6 is a view showing the opening and closing plate of the filter according to the present disclosure.

FIG. 7 is a view showing the opening and closing plate and the lower cover according to the present disclosure.

FIG. 8 is a view showing the base member of the filter according to the present disclosure.

FIG. 9 is a view showing the water discharge pipe of the filter according to the present disclosure.

FIG. 10 is a view showing the flow of a fluid through the water discharge pipe in the filter according to the present disclosure.

FIG. 11 is a view showing another example of the water discharge pipe of the filter according to the present disclosure.

FIG. 12 is a side view showing the flow of a fluid through another example of the water discharge pipe of the filter according to the present disclosure.

FIG. 13 is a sectional view showing the flow of a fluid through another example of the water discharge pipe of the filter according to the present disclosure.

FIG. 14 is a view showing yet another example of the water discharge pipe of the filter according to the present disclosure.

FIG. 15 is a side view showing the flow of a fluid through yet another example of the water discharge pipe of the filter according to the present disclosure.

FIG. 16 is a sectional view showing the flow of a fluid through yet another example of the water discharge pipe of the filter according to the present disclosure.

FIG. 17 is a view showing the flow of a fluid through the water discharge pipe of a conventional filter.

### DETAILED DESCRIPTION

Hereinafter, the present disclosure will be described in detail with reference to the attached drawings so that it can be easily carried out by a person of ordinary skill in the art. The present disclosure may be modified in various ways and may have several exemplary embodiments. Specific exemplary embodiments of the However, this does not limit the disclosure within specific embodiments. In the drawings, portions having no relation with the explanation of the present disclosure are omitted, and in the description, the corresponding parts in the embodiments of the present disclosure are indicated by corresponding reference numerals.

The term ‘including’ and/or ‘having’, as used herein are intended to refer to the above features, numbers, steps, operations, elements, parts or combinations, and it is to be understood that the terms are not intended to preclude the presence of one or more features, numbers, steps, operations, elements, parts or combinations and added possibilities.

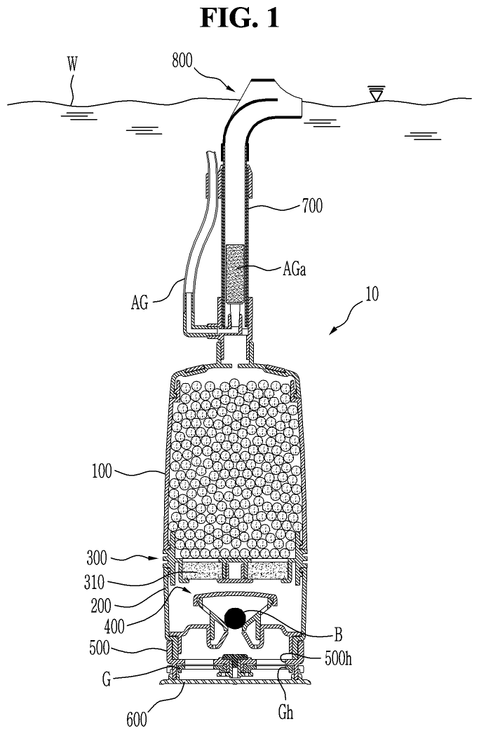

Referring to FIG. 1, a filter 10 according to the present disclosure is located on the bottom of a water tank F. In this case, a fluid W is introduced into an opening and closing hole Gh of an opening and closing plate G, passes through a lower cover 500, an escape prevention member 400, a lower body 200, a connector 300, an upper body 100, and a water discharge pipe 800, and is thus circulated to the water tank F.

The filter 10 according to the present disclosure includes the upper body 100, the lower body 200, the connector 300, the escape prevention member 400, the lower cover 500, the opening and closing plate G, and the water discharge pipe 800.

The upper body 100 is cylindrical and is filled with a filter medium. Further, an air supply member AG is connected to the upper portion of the upper body 100 to supply air to the fluid W.

The lower body 200 is cylindrical and open on top and bottom thereof. Further, the lower body 200 is connected to the upper body 100 by means of the connector 300 connected to top thereof. In addition, the lower body 200 is configured to allow the fluid W and sludge S to be introduced into the inside from the bottom thereof.

The connector 300 is located between the upper body 100 and the lower body 200 to allow the inside of the upper body 100 to communicate with the inside of the lower body 200. Further, the connector 300 has an inflow prevention member 310 located at the inside thereof to prevent the sludge S introduced into the inside of the lower body 200 from entering the upper body 100. In this case, the inflow prevention member 310 is made of a sponge or porous filter.

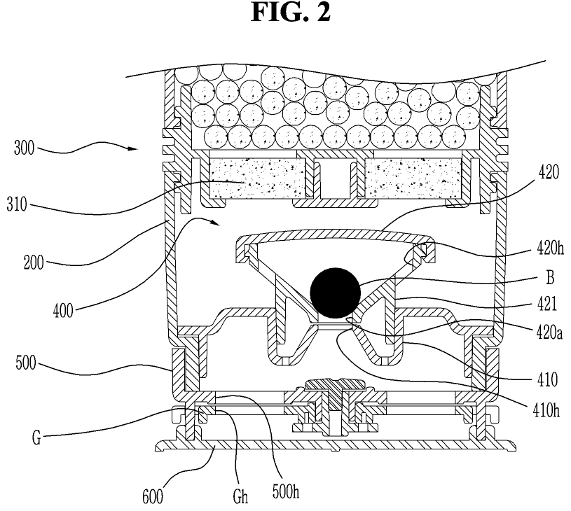

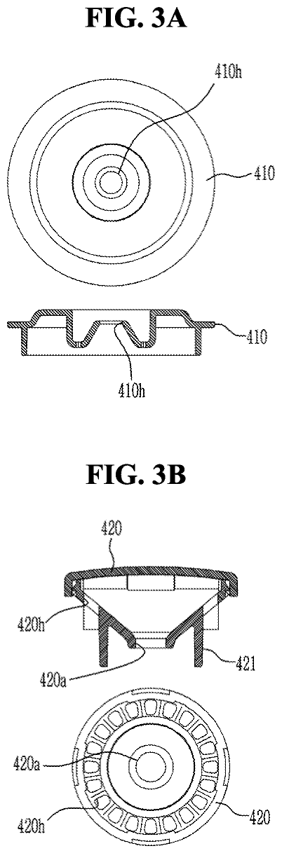

Referring to FIGS. 2 to 3b, the escape prevention member 400 is located inside the lower body 200 to allow the sludge S and the fluid W to be introduced into the lower body 200. Further, the escape prevention member 400 prevents the sludge S introduced into the lower body 200 from escaping from the lower body 200 to the outside.

In this case, the escape prevention member 400 includes a support plate 410, a center pipe 420, and a backflow prevention ball B. The support plate 410 is fixed to the inside of the lower body 200 and has a through hole 410h formed at the center thereof.

The center pipe 420 is fixed to top of the support plate 410 and has a tapered shape increasing in diameter toward the upper side thereof. Further, the center pipe 420 has a lower hole 420a formed on the bottom thereof in such a manner as to communicate with the through hole 410h and at least one or more connection holes 420h formed on one side of the upper portion thereof. Also, the center pipe 420 is closed on top thereof. Moreover, the center pipe 420 has a fixing rod 421 protruding downward from the side thereof in such a manner as to be fixed to the support plate 410 to prevent the movements thereof.

The backflow prevention ball B is movable inside the center pipe 420. In this case, as the backflow prevention ball B moves in the center pipe 420, it selectively opens and closes the lower hole 420a to prevent the fluid W from flowing back.

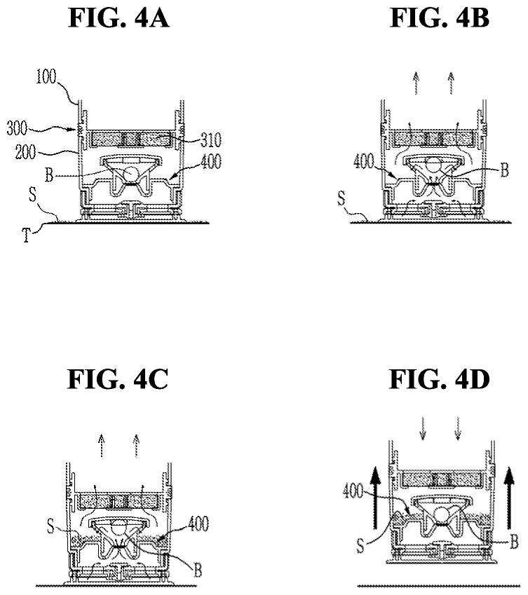

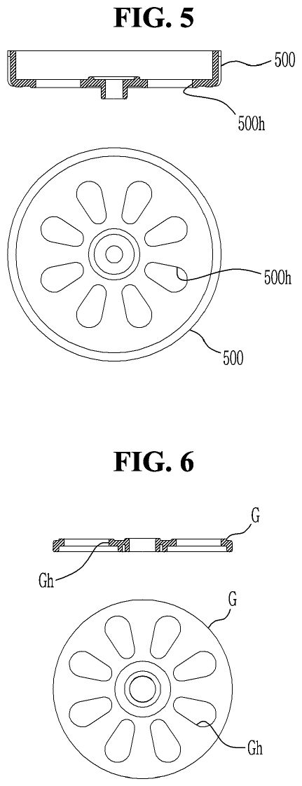

Referring to FIGS. 4a to 4d, if the fluid W and the sludge S are introduced from the space under the escape prevention member 400 into the lower body 200 via the through hole 410h, the lower hole 420a, and the connection holes 420h, the backflow prevention ball B moves from the inside of the center pipe 420 to the upper side thereof so that the lower hole 420a becomes open.

If it is desired to remove the filter 10 from the water tank F by a user, further, the backflow prevention ball B moves from the inside of the center pipe 420 to the lower side thereof so that the lower hole 420a becomes closed to prevent the sludge S and the fluid W existing at the inside of the lower body 200 from escaping from the lower body 200 to the interior of the water tank W through the lower hole 420a.

The lower cover 500 is coupled to the lower portion of the lower body 200 to surround the lower body 200. In this case, the lower cover 500 has at least one or more inflow holes 500h formed radially thereon.

The opening and closing plate G is connected to the lower cover 500. Further, the opening and closing plate G has at least one or more opening and closing holes Gh formed radially thereon in such a manner as to open and close the inflow holes 500h.

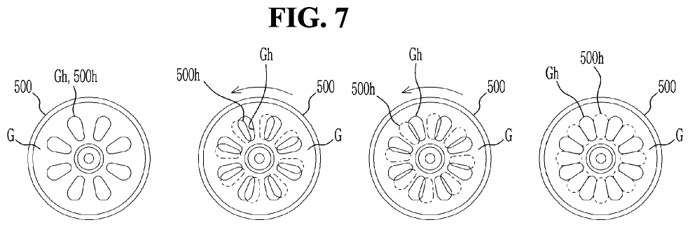

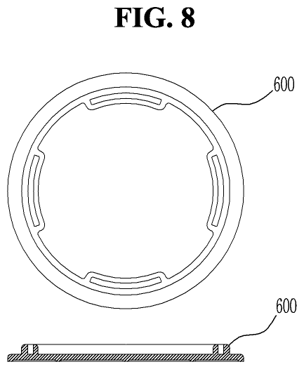

Referring to FIG. 7, the opening and closing plate G serves to adjust the sizes of the inflow holes 500h of the lower cover 500 so that the flow rate of the fluid W introduced into the lower body 200 can be regulated. Through the adjustment of the sizes of the inflow holes 500h of the lower cover 500, further, the opening and closing plate G prevents baby or small fishes from entering the lower body 200.

The water discharge pipe 800 has one end portion connected to top of the upper body 100. Further, the fluid W passing through the opening and closing holes Gh, the inflow holes 500h, the escape prevention member 400, the lower body 200, the connector 300, and the upper body 100 can be discharged through the water discharge pipe 800. Also, the water discharge pipe 800 has a shape of a pipe bent to prevent a vortex from being generated from the interior thereof.

The water discharge pipe 800 has an inlet 800a formed on one end portion thereof and an outlet 800b formed on the other end portion thereof in such a manner as to have an angle of 80 to 120° with respect to each other. In this case, of course, the inlet 800a and the outlet 800b of the water discharge pipe 800 may be located vertically to each other. Further, the water discharge pipe 800 is made of a luminescent material to improve visibility.

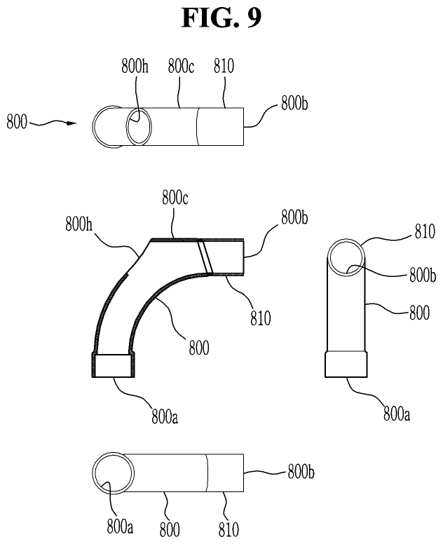

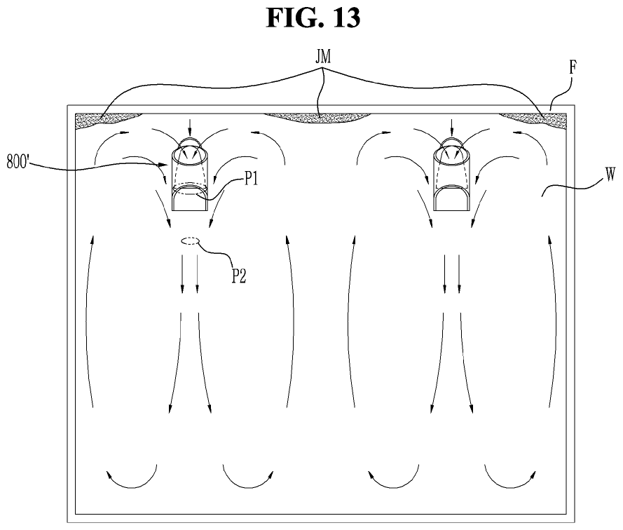

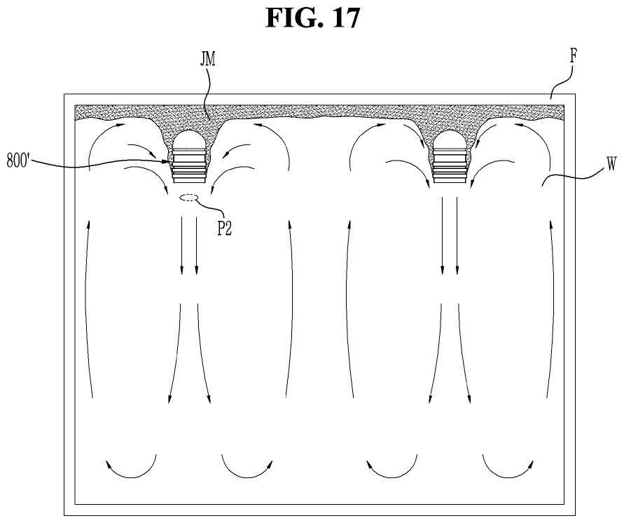

Referring to FIGS. 9 to 16, first to third examples of the water discharge pipe 800 will be explained.

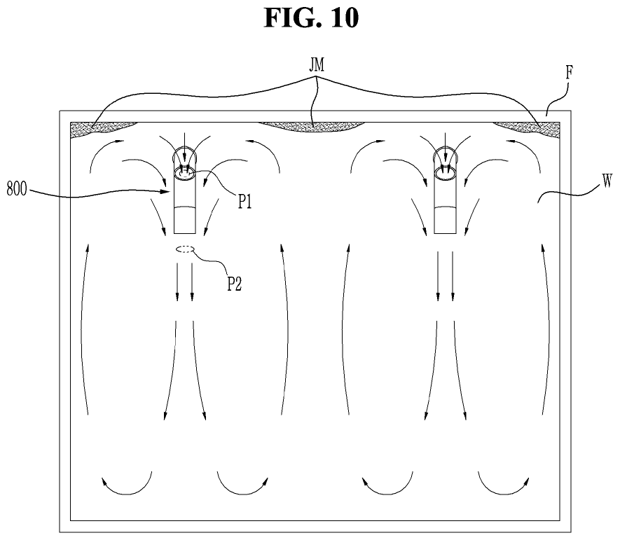

Referring first to FIGS. 9 and 10, the water discharge pipe 800 according to the first example has a fluid inflow hole 800h formed on a side portion thereof, and the fluid W is introduced from the inlet 800a and the fluid inflow hole 800h and easily discharged. Further, the water discharge pipe 800 has a top end portion 800c formed on top thereof in such a manner as to prevent the fluid W introduced from the inlet 800a from being discharged to top of the fluid W filled in the water tank F.

That is, the fluid W introduced from the inlet 800a of the water discharge pipe 800 moves in an upward direction and is thus discharged in the upward direction, but in this case, the fluid W collides against the top end portion 800c so that it cannot be discharged in the upward direction.

Referring to FIGS. 1 and 10, the water discharge pipe 800 is located to allow the fluid inflow hole 800h to be disposed on the surface of the fluid W filled in the water tank F, so that through the fluid inflow hole 800h, the fluid is introduced.

Accordingly, the filter 10 according to the present disclosure is configured to allow the fluid W to move at a first point P1 as the fluid inflow hole 800h of the water discharge pipe 800 as well as a second point P2 as the outlet 800b of the water discharge pipe 800, thereby breaking oil films. As a result, the filter 10 according to the present disclosure can reduce the oil film staying sections JM generated from the water tank F.

Further, the water discharge pipe 800 is connected to a luminescent cap 810 on the other end portion thereof. That is, the luminescent cap 810 is connected to the outlet side of the water discharge pipe 800 to improve visibility of the water discharge pipe 800.

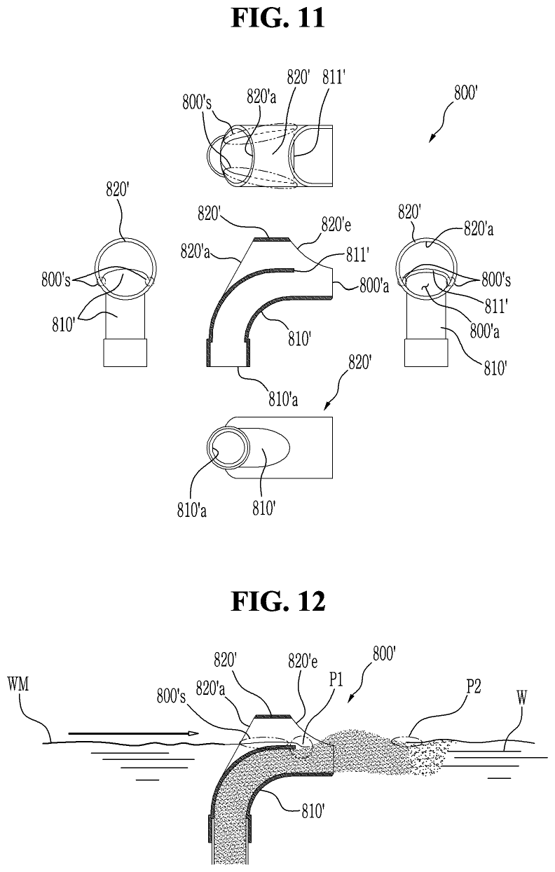

Referring next to FIGS. 11 to 13, the water discharge pipe 800′ according to the second example has an underwater pipe 810′ and an over water cap 820′. The underwater pipe 810′ is bent.

The over water cap 820′ is connected to both sides of top of the underwater pipe 810′. The over water cap 820′ is connected to the underwater pipe 810′ to provide a fluid inlet 820′a behind an outlet 800′a of the underwater pipe 810′.

Further, the over water cap 820′ forms inflow spaces 800's, together with the underwater pipe 810′, to allow the fluid W introduced into the fluid inlet 820′a to flow to the outlet 800′a of the underwater pipe 810′.

On the other hand, the fluid W of the water tank F is introduced through the fluid inlet 820′a and thus flows to the outlet 800′a of the underwater pipe 810′. In this case, the inflow spaces 800's are narrower than the space of the fluid inlet 820′a, and accordingly, the fluid W flowing through the inflow spaces 800's has a faster flow rate than the fluid W flowing through the fluid inlet 820′a. Accordingly, the oil film WM from the fluid W flowing through the inflow spaces 800's can be more gently removed.

Further, the underwater pipe 810′ has a top end portion 811′ adapted to form a stepped portion between the fluid W discharged to the outlet 800′a from an inlet 810′a thereof and the fluid W flowing to the outlet 800′a thereof through the inflow spaces 800's of the over water cap 820′.

Referring to FIG. 12, the water discharge pipe 800′ according to the second example is configured to allow the oil films WM to be broken at a first point P1 on the top end portion 811′ of the underwater pipe 810′ as well as a second point P2 on the outlet 800′a of the underwater pipe 810′, thereby gently removing the oil films WM formed on the surface of water. Further, the filter 10 according to the present disclosure reduces the oil film staying sections JM generated in the water tank F through the inflow spaces 800's of the over water cap 820′. Also, the over water cap 820′ has a front portion 820′e inclined forward therefrom to prevent air bubbles from being attached to the inside thereof.

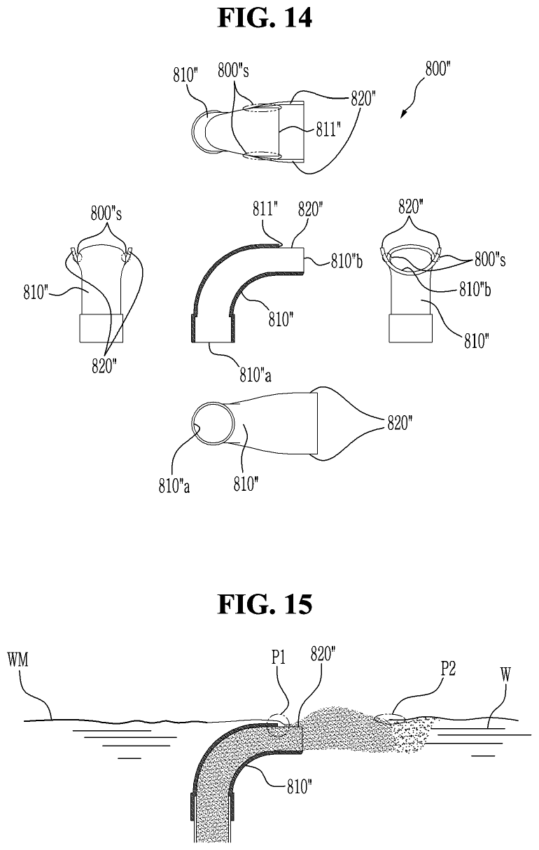

Referring next to FIGS. 14 to 16, the water discharge pipe 800″ according to the third example has an underwater pipe 810″ and over water wings 820″. The underwater pipe 810″ is bent.

The over water wings 820″ are connected to the underwater pipe 810″ in such a manner as to protrude upward from both sides of top of the underwater pipe 810″. Further, the over water wings 820″ form inflow spaces 800″s, together with the underwater pipe 810″, to allow the fluid W behind an outlet 810″b of the underwater pipe 810″ to flow to the outlet 810″b of the underwater pipe 810″.

Additionally, the water discharge pipe 800″ according to the third example further includes an upward convex arch-shaped over water cap whose both ends are connected to the top ends of the over water wings 820″ to connect the over water wings 820″ to each other, so that the water discharge pipe 800″ can function as the water discharge pipe 800′ according to the second example.

Further, the fluid W flowing through the inflow spaces 800″s has a faster flow rate than the fluid W flowing through the underwater pipe 810″. Accordingly, the oil films WM from the fluid W flowing through the inflow spaces 800″s can be more gently removed. If the water discharge pipe 800″ is submergedly located in the fluid W, the fluid W behind and beside the water discharge pipe 800″ can flow to the outlet 810″b of the underwater pipe 810″.

Further, the underwater pipe 810″ has a top end portion 811″ adapted to form a stepped portion between the fluid W discharged to the outlet 810″b from an inlet 810″a thereof and the fluid W flowing to the outlet 810″a thereof through the inflow spaces 800″s.

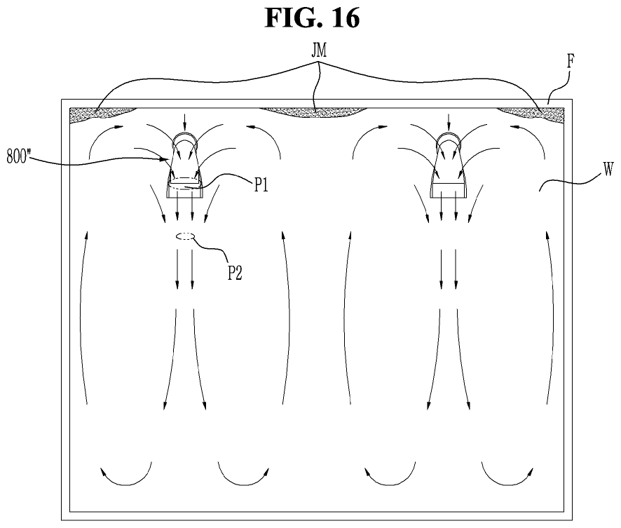

Referring to FIG. 15, the water discharge pipe 800″ according to the third example is configured to allow the oil films WM to be broken at a first point P1 on the top end portion 811″ of the underwater pipe 810″ as well as a second point P2 on the outlet 810″b of the underwater pipe 810″, thereby gently removing the oil films WM formed on the surface of water. Further, the filter 10 according to the present disclosure reduces the oil film staying sections JM generated in the water tank F through the inflow spaces 800″s.

Referring again to FIG. 1, the filter 10 according to the present disclosure further includes a base member 600 and a height adjustment pipe 700.

Further, the opening and closing holes Gh are extended to the side portion of the opening and closing plate G. That is, the fluid W can be introduced from the side portion of the opening and closing plate G to the opening and closing holes Gh.

The base member 600 is connected to the underside of the opening and closing plate G to close the undersides of the opening and closing holes Gh, thereby preventing sand from being introduced through the undersides of the opening and closing holes Gh. Accordingly, the fluid W is introduced into the inflow holes 500h through the sides of the opening and closing holes Gh.

The height adjustment pipe 700 is located between the upper body 100 and the water discharge pipe 800 to connect the upper body 100 to the water discharge pipe 800 and to adjust the height of the water discharge pipe 800.

As a result, the filter 10 according to the present disclosure can prevent, when removed from the water tank F, the sludge S collected therein from escaping therefrom to the inside of the water tank F through the escape prevention member 400.

Further, the filter 10 according to the present disclosure can break the oil films on the inlet of the water discharge pipe 800 as well as on the fluid inflow hole 800h or the top end portion 811′ of the underwater pipe 810′, thereby gently removing the oil films formed on the surface of water. Moreover, the oil film staying sections JM generated from the water tank F can be reduced through the fluid inflow hole 800h or the inflow spaces 800's.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

1. A filter comprising:
an upper body whose interior is filled with a filter medium;
a lower body located under the upper body in such a manner as to be open on top and bottom thereof; and
an escape prevention member located inside the lower body to allow sludge and a fluid to be introduced into the lower body and to prevent the sludge from escaping from the lower body,
wherein the escape prevention member comprises:
a support plate fixed to the inside of the lower body and having a through hole formed at the center thereof;
a center pipe fixed to top of the support plate and having a lower hole formed on the bottom thereof in such a manner as to communicate with the through hole and at least one or more connection holes formed on one side thereof; and
a backflow prevention ball movable inside the center pipe in such a manner as to selectively open and close the lower hole to prevent the fluid from flowing back.

2. The filter according to claim 1, further comprising a connector located between the upper body and the lower body to allow the inside of the upper body to communicate with the inside of the lower body and an inflow prevention member located at the inside of the connector to prevent the sludge introduced into the inside of the lower body from entering the upper body.

3. The filter according to claim 1, further comprising a lower cover adapted to surroundingly cover the lower portion of the lower body and having at least one or more inflow holes formed radially thereon and an opening and closing plate connected to the lower cover and having at least one or more opening and closing holes formed radially thereon in such a manner as to selectively open and close the inflow holes.

4. The filter according to claim 1, further comprising a water discharge pipe connected to top of the upper body on one end portion thereof in such a manner as to discharge the fluid passing through the lower body, the escape prevention member, and the upper body.

5. The filter according to claim 1, further comprising an air supply member connected to the upper portion of the upper body to supply air to the fluid.

6. The filter according to claim 3, further comprising a base member connected to the underside of the opening and closing plate in such a manner as to close the undersides of the opening and closing holes to prevent sand from being introduced through the undersides of the opening and closing holes.

7. The filter according to claim 1, further comprising a height adjustment pipe located between the upper body and the water discharge pipe in such a manner as to connect the upper body to the water discharge pipe and to adjust the height of the water discharge pipe.

8. A filter comprising:
an upper body whose interior is filled with a filter medium;
a lower body located under the upper body in such a manner as to be open on top and bottom thereof; and
a water discharge pipe connected to top of the upper body on one end portion thereof in such a manner as to discharge a fluid passing through the lower body and the upper body,
wherein the water discharge pipe comprises a fluid inlet formed on one side thereof to prevent a vortex from being generated from the interior thereof.

9. The filter according to claim 8, wherein the other end portion of the water discharge pipe is connected to a luminescent cap or made of a luminescent material.

10. A filter comprising:
an upper body whose interior is filled with a filter medium;
a lower body located under the upper body in such a manner as to be open on top and bottom thereof; and
a water discharge pipe connected to top of the upper body on one end portion thereof in such a manner as to discharge a fluid passing through the lower body, an escape prevention member, and the upper body,
wherein the water discharge pipe comprises:
an underwater pipe bentedly shaped in such a manner as to be connected to top of the upper body; and
over water wings protruding upward from both sides of top of the underwater pipe in such a manner as to form inflow spaces, together with the underwater pipe, to allow the fluid behind an outlet of the underwater pipe to flow to the outlet of the underwater pipe.

11. The filter according to claim 10, wherein the water discharge pipe comprises an upwardly convex arch-shaped over water cap whose both ends are connected to the top ends of the over water wings in such a manner as to connect the over water wings to each other.

12. The filter according to claim 11, wherein the over water cap has a front portion inclined forward therefrom to prevent air bubbles from being attached to the inside thereof.

13. The filter according to claim 10, wherein the underwater pipe has a top end portion adapted to form a stepped portion between the fluid discharged to the outlet thereof from an inlet thereof and the fluid flowing to the outlet thereof through the inflow spaces.
